(19) United States
(12) Patent Application Publication
(10) Pub. No.: US 2008/0037089 A1
(43) Pub. Date: Feb. 14, 2008

(54) Apparatus for the distribution of laser light

(76) Inventors: Johann Klausner, St. Jakob (AT); Kurt Iskra, Kumberg (AT)

Correspondence Address: WENDEROTH, LIND & PONACK, L.L.P., 2033 K STREET N. W., SUITE 800, WASHINGTON, DC, 20006-1021, US

(21) Appl. No.: 11/889,157

(22) Filed: Aug. 9, 2007

(30) Foreign Application Priority Data
Aug. 9, 2006 (AT) A 1335/2006

(51) Int. Cl. G02B 26/08

(52) U.S. Cl. 359/196

(57) ABSTRACT

An apparatus for the distribution of laser light from a light source (3) and/or an entry light waveguide (1) on to at least two and in particular a plurality of exit light waveguides (2), wherein the apparatus has at least one light deflection element (4) which rotates, preferably continuously, in operation of the apparatus and which is provided for deflecting laser light out of the entry light waveguide (1) and/or the light source (3) in the direction of the exit light waveguides (2).

The present invention concerns an apparatus for the distribution of laser light from a light source and/or an entry light waveguide on to at least two and in particular a plurality of exit light waveguides. In addition the invention concerns a laser ignition arrangement and an internal combustion engine, in particular a gas engine, having such an apparatus.

Conventional diode-pumped solid-state lasers which are used for example in the sector of laser ignition for internal combustion engines generally obtain their pump energy from laser diodes which either are directly coupled to the laser medium or which are connected to the laser medium by way of an optical fiber.

There are various concepts for the distribution of fiber-guided laser radiation from a source to a plurality of consumers. In the field of telecommunications, electro-opticaly modulated multiplexers and demultiplexers are used, with which however only very low levels of power—that is to say in principle only items of information—can be transmitted. Further concepts are based on demands which involve superpositioning of fiber ends by mechanical adjusting devices, and that requires high-precision orientation and reproduction accuracy and is thus disadvantageous.

Other concepts propose free beam coupling arrangements which involve an additional optical expansion at the transmitter end and subsequent collimation at the receiver end, which however also increases the overall complexity of the system. Particularly for use for ignition arrangements in internal combustion engines, there are at the present time no concepts which could guarantee continuous operation at a speed which does justice to the demands of an internal combustion engine. In particular the arrangements of the general kind set forth, which hitherto are known by the name of multiplexer and demultiplexer, are however also not suitable for transporting pump radiation through a fiber-coupled assembly, over a period of time which is sufficiently long for internal combustion engine ignition arrangements.

Therefore the object of the invention is to provide an apparatus of the general kind set forth which is suitable in particular for use for laser ignition arrangements of an internal combustion engine.

That is achieved in that the apparatus has at least one light deflection element which rotates, preferably continuously, in operation of the apparatus and which is provided for deflecting laser light out of the entry light waveguide and/or the light source in the direction of the exit light waveguides.

By virtue of the arrangement according to the invention it is possible to use only one pump light source for the ignition of a plurality of cylinders of an internal combustion engine. By way of the arrangement according to the invention, the pump light source supplies the cylinders of the internal combustion engine with pump laser radiation successively in time-staggered relationship in accordance with the ignition sequence. That affords a substantial cost advantage as it is possible to save on a plurality of pump light sources, in comparison with the previously known concepts. In that respect, particularly for the use of internal combustion engines, it is desirable if the apparatus is suitable for the transmission of laser light, preferably pump laser light, of a power of at least 10 W (watts), preferably at least 100 W, preferably with a level of efficiency of at least 80%, and/or if the apparatus is suitable in continuous operation for the transmission of laser light, preferably pump laser light, on to a respective exit light waveguide 2, during time intervals involving interval lengths of between 50 μs (microseconds) and 8000 μs, preferably between 100 μs and 500 μs. In that case the efficiency is determined from the ratio of the total pulse energy of the pump pulse at the light entry surface of the exit light waveguide to the total pulse energy of the pump pulse at the light entry surface of the light deflection element. In principle however the apparatus according to the invention can be used both for the transmission of continuous laser light and also pulsed laser light.

A variant of the apparatus according to the invention, which is particularly simple to implement from a mechanical point of view and which is thus extremely stable can be afforded if the light deflection element in operation rotates continuously in one direction of rotation, wherein it is preferably provided that the light deflection element deflects the laser light successively in the direction of the various exit light waveguides. Apparatuses which are particularly stable in operation and which involve a low level of maintenance can be provided if the light deflection element is the single, movably mounted optically operative component of the apparatus.

Among the apparatuses according to the invention, there are in particular two groups. In regard to the first, it is provided that the laser deflection element is so designed that laser light which is transmitted through the light deflection element, preferably the focus thereof, can be deflected by the light deflection element in its direction of propagation. The other provides that the light deflection element is so designed that the laser light, preferably the focus thereof, can be deflected by reflection at the light deflection element in its direction of propagation.

In principle apparatuses according to the invention can be implemented with all known types of entry light waveguides and/or exit light waveguides. Preferably however there are provided embodiments in which the entry light waveguide and/or the exit light waveguide are optical fibers.

Further features and details of the present invention will be apparent from the specific description hereinafter. In the drawing:

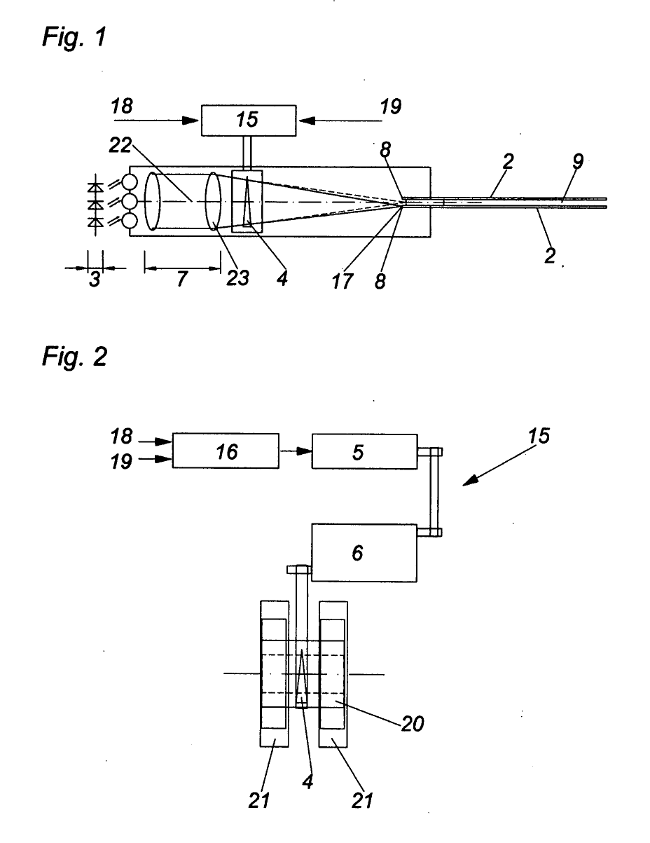

FIGS. 1 through 3 serve to describe an embodiment by way of example according to the invention in which the laser light is transmitted through the light deflection element,

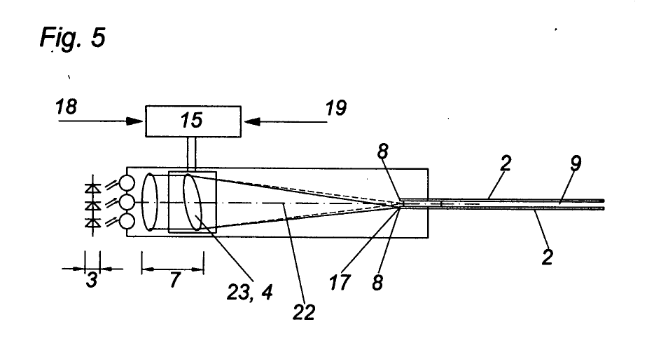

FIGS. 4 and 5 serve to describe alternative configurations according to the invention of the embodiment of FIGS. 1 through 3, and

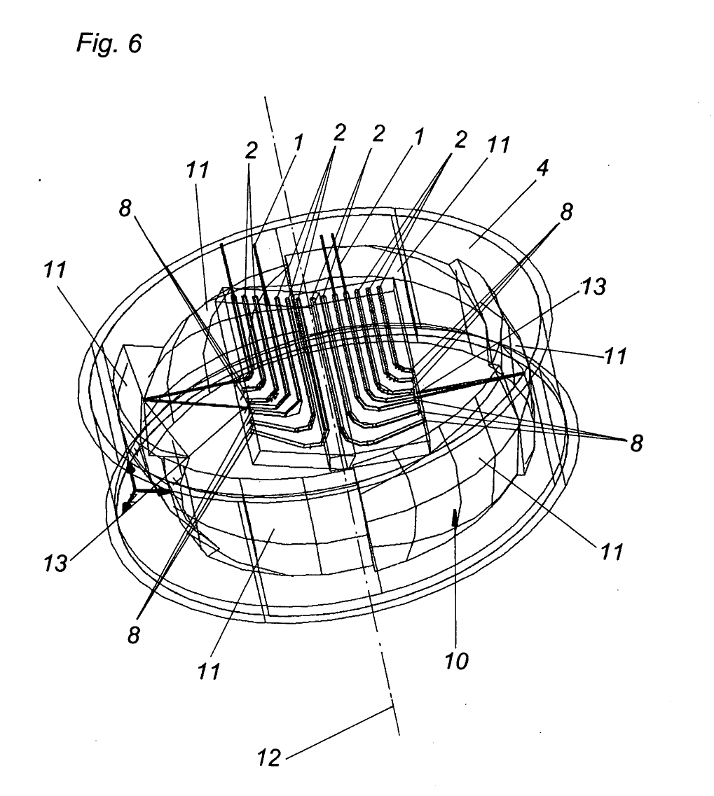

FIG. 6 serves to describe an embodiment in which the light deflection element operates with reflected laser light beams.

With all illustrated embodiments, there is proposed a respective apparatus according to the invention which in a continuously operating arrangement without involving a high level of additional complication and expenditure distributes laser radiation produced by a pump diode or pump diode arrangement or other suitable light source in a pulsed mode of operation on to a plurality of exit light waveguides which can transport the laser radiation in further succession to the laser resonators or laser amplifiers to be pumped—preferably of the cylinders. The proposed arrangements ensure sufficiently long optical superpositioning of the light source 3 or entry light waveguide 1 and the respective exit light waveguides 2 without interrupting the continuous movements involved. When using laser ignition arrangements for internal combustion engines, it is desirably provided in that respect that synchronisation devices are provided for synchronising the rotary movement of the light deflection element 4 with the rotary speed and the required ignition angle of the internal combustion engine. For that purpose, the apparatus shown in FIGS. 1 through 3 has the drive 15 for the light deflection element 4, the drive being described in greater detail hereinafter with reference to FIG. 2.

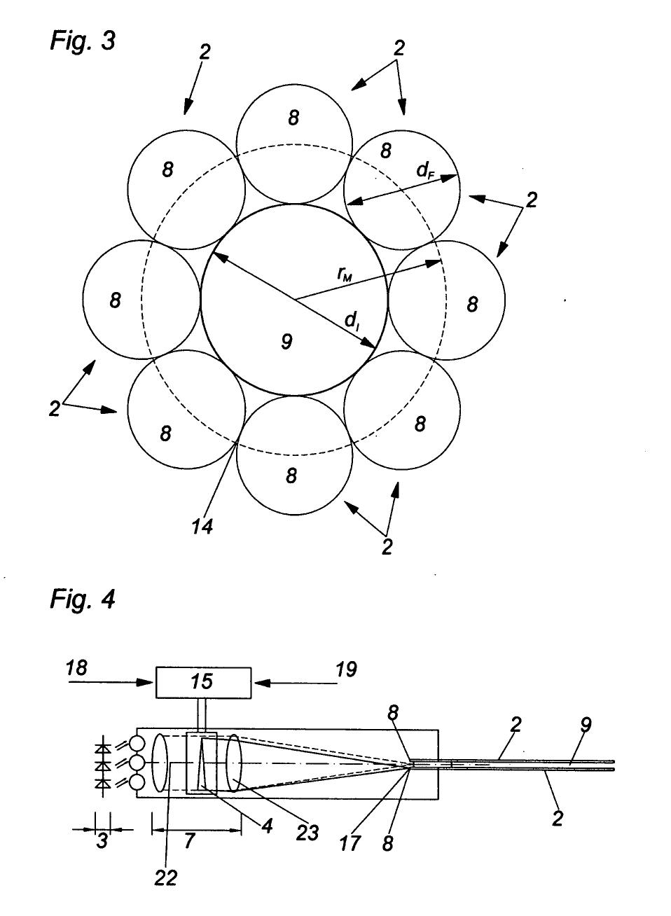

As shown in particular in FIG. 1, the laser light generated by the light source 3 which is in the form of a plurality of laser diodes is coupled into a focusing optical means 7 after collimation and operationally implemented re-stacking. The optical means 7 serves for generating the focus 17 of the laser light. Provided for distributing the laser light on to a plurality of exit light waveguides 2—here in the form of optical fibers—is the rotating light deflection element 4 which is displaced in a continuous rotary movement by way of the drive 15 which is described in greater detail hereinafter. In the illustrated embodiment the light deflection element 4 is in the form of a slightly wedge-shaped prism which rotates synchronously with the speed of rotation of the internal combustion engine about the focusing axis 22 and thereby causes a slight defined angular deflection of the focus 17 of the laser light with respect to the focusing axis 22. In that respect it is possible for the configuration to be based in particular on a slightly wedge-shaped prism if at least two of the wedge surfaces of the wedge-shaped prism include with each other an angle of a maximum of 10°, preferably a maximum of 5°. The slight angular deviations between the focus 17 and the focusing axis 22 are desirably in an angular range of between 0.5° and 5°, preferably in an angular range of between 1° and 2°. On the assumption of a focal length of the focusing optical means 7 of 30 mm and a spacing between the prism 4 and the beam entry surface 8 of 20 mm, with the data of the calculation example hereinafter, that affords a deflection angle in respect of the beam of 1.5° and a prism angle of 3° when using conventional kinds of glass with a refractive index of 1.5. By rotation of the prism and the angular deviation achieved in respect of the focus 17 the laser light generated by means of the light source 3 is successively deflected on to the individual light entry surfaces 8 of the exit light waveguides 2. In the preferred arrangement as shown in FIG. 3 the light entry surfaces 8 of the exit light waveguides 2 are arranged in mutually adjoining paired relationship on a closed line—here in the form of a circle 14. In that respect the rotationally symmetrical arrangement of FIG. 3 is preferred. That is afforded if the exit light waveguides 2 are wound around a common center 9 at least in the region of the apparatus. In principle however it is also possible to adopt arrangements differing from that rotational symmetry in respect of the laser light entry surfaces 8 of the exit light waveguides 2. In order not to have to interrupt the continuously rotating movement of the light deflection element 4 the exit light waveguides or the light entry surfaces 8 thereof should be of a suitably large cross-section d_{F} so that sufficiently long superpositioning of the area of the focus 17 of the laser light with the respective light entry surface 8 is guaranteed. If required for that purpose the coating of the optical fibers can be removed.

In order to achieve maximum possible density in the arrangement of the light entry surfaces 8 the cross-section of the center 9 should be kept as small as possible. A dense arrangement of the laser light entry surfaces 8 contributes to the fact that, within the pump duration of the laser diodes forming the light source 3, the area of the focus 17 of the pump laser light overlaps the light entry surface 8 of the respective light exit waveguide 2 for a sufficiently long time. In general a number of exit light waveguides 2, corresponding to the number of cylinders of the internal combustion engine, is to be provided.

The following calculation formulae apply:

| | |
|---|---|
| Predetermined parameters: | Fiber diameter: d_{f} |
| | Rotary speed: n |
| | Number of cylinders: z |
| | Focal point diameter: d_{B} |
| That gives: | sector angle α = 360°/z |
| The radius of the center point circle: | r_{M} = d_{f}/(2 sin (α/2)) |
| The diameter of the central part: | d₁ = 2(r_{M} − d_{f}/2) |
| The coupling-in internal of the focal point: | t_{E} = [(d_{f} − d_{B})/(2r_{M}Π)]/(n/60) |

Applicant: deadline: (n/60) in the case of two-stroke operation, (2n/60) in the case of four-stroke operation and 2-times stepdown of the prism drive.

That coupling-in interval is to be longer than the pump duration of the laser medium. For that purpose it is necessary for the diameter of the focal point d_{B} to be sufficiently small in relation to the diameter of the waveguide d_{f}.

FIG. 3 thus shows, on the basis of its eight exit light waveguides 2, an embodiment of a multiplexer for an eight-cylinder internal combustion engine. In the illustrated embodiment there is provided a fiber diameter d_{f} of the exit light waveguides 2 of 600 μm in each case. That results in a minimum diameter d₁ of the center 9 of 968 μm. With a rotary speed of 6000 revolutions per minute a point on the center point circle 14 of the radius r_{M}=783 μm, in the typical pump operating duration of 250 μs (microseconds), passes over a distance of 123 μm (micrometers) in the two-stroke mode and 61.5 μm in the four-stroke mode. In this example that means that, with a diameter in respect of the focus 17 of 400 μm, the laser light can still be coupled for a sufficiently long period into the respective exit light waveguides 2, with a sufficient safety margin.

FIG. 2 shows in an embodiment how the drive 15 for producing the rotary movement of the light deflection element can be designed. What is important for proper operability is a motor 5 which is accurate in terms of its position and which can be matched to the rotary speed and a rotary angle of the internal combustion engine to be ignited. Preferably electric motors and in particular synchronous motors are used for that purpose. In order to ensure a movement of the light deflection element 4, which is as continuous as possible, the arrangement comprises a step-down transmission or reduction gear unit 6—similarly to a clockwork mechanism. In the illustrated embodiment that transmits the rotary movement to a cylindrical receiving means 20 in which the prism forming the light deflection element 4 is held. The cylindrical receiving means 20 is supported in two bearings 21 and rotates together with the prism. The motor 5 is actuated by an electronic monitoring and control system 16 which determines the rotary speed of the motor 5 in dependence on the rotary speed presetting 18 of the internal combustion engine and the ignition angle presetting 19 which is preferably taken from a mapping. The advantages of the arrangements shown in FIGS. 1 through 3 are in particular that the beam path is only slightly deflected by the weakly optically deflecting light deflection element 4 but is otherwise not substantially changed. The precision demands on the mechanical components of the illustrated apparatus are low. The sole moving optical part is the deflection prism. The light source 3, the focusing optical means 7 and the exit light waveguides 2 are not moved. Errors in orientation—such as misalignment or out-of-true—have only a slight effect on the resultant beam deflection because of the small aperture angle necessary. The necessary aperture angle of the deflection prism can be easily achieved with the necessary degree of accuracy, in the state of the art. The necessary precision in respect of the arrangement of the light entry surfaces 8 of the exit light waveguides 2 can be maintained with a low level of complication and expenditure because of the reproducible and accurate diameter of the fibers and the static arrangement.

FIGS. 4 and 5 show two alternatives to the embodiment described hereinbefore. In FIG. 4 the rotating prism as the light deflection element 4 is disposed in front of the focusing lens 23 of the focusing optical means 7. That variant can be adopted if the space between the focusing lens 23 and the exit light waveguide 2 is small.

As shown in FIG. 5 the light deflection element 4 can also be embodied by suitable tilting of the focusing lens 23. In that case therefore the tilted focusing lens 23 is rotated as the light deflection element 4.

As already explained in the opening part of this specification, in contrast to the embodiments of FIGS. 1 through 5, FIG. 6 shows an arrangement according to the invention in which the light is deflected at the rotating light deflection element 4 by reflection, in respect of its direction of propagation. In the case of this group of embodiments it is preferably provided that the light deflection element 4 is of a substantially annular and/or disk-shaped configuration and has a reflection surface 10 at its inside face or surface. In that respect, in the case of the embodiments which can be particularly well governed in mechanical terms and which continuously rotate in one direction of rotation, it is preferable if the reflection surface 10 extends in at least one direction in space over an angular range of 360°. Both in the case of light deflection elements 4 which are of an annular configuration and also those which are of a disk-shaped configuration it is desirable if the reflection surface 10 has a sequence of mutually tilted, preferably immediately adjoining, curved surface segments, preferably spherical surface segments 11. The curved surface segments of the reflection surface 10 are in that case usually in the form of mirrors involving a different inclination. The rapidity of the switching-over operation depends on the periphery of the disk or ring forming the light deflection element 4—like on the speed of revolution and the laser beam diameter.

In the embodiment shown in FIG. 6 the light deflection element 4 is of an annular configuration. It rotates about the axis of rotation 12. The entry light waveguides 1 and the exit light waveguides 2 as well as the associated laser light exit surfaces 13 and laser light entry surfaces 8 in this embodiment are arranged stationarily centrally within the light deflection element 4 of an annular configuration. The illustrated embodiment has two entry light waveguides 1, the laser light of which is respectively distributed on to a plurality of exit light waveguides 2. For distribution of the laser light the annular rotating light deflection element 4 has a reflection surface 11 formed from a succession of differently inclined spherical surface segments 11. The spherical surface segments 11 are each of the same spherical radius and are in directly adjoining relationship. The reflecting surfaces are respectively in the form of mirrors. The mirrors forming the spherical surface segments 11 are each curved in such a way that the center of the curvature is the center of rotation of the ring. That is achieved by the center points of at least two and preferably all spherical surface segments 11 being disposed on the axis of rotation 12 of the annular light deflection element 4. That ensures that the laser beam is constantly coupled into one of the exit light waveguides 2 when passing through a sector or a spherical surface segment 11. The curvature of the mirrors or spherical surface segments 11 is so selected that the focusing of the laser beam is the same at each mirror and the laser beam is not distorted thereby. In order to achieve the necessary tilt angle between the individual spherical surface segments 11 the center points of each two adjacent spherical surface segments 11 are disposed in mutually displaced relationship in the direction of the axis of rotation 12 of the annular light deflection element 4. They are therefore displaced relative to each other in their vertical height. The angular deviation of the laser beams should be as small as possible so that the beam is distorted as little as possible. It is desirable in that respect if the magnitude of the angle between a laser light beam issuing from the light source 3 and/or the entry light waveguide 1 and the laser light beam reflected at the light deflection element 4 is at most 45°, preferably at most 20°, in which respect negative as well as positive angles are possible. The path between the laser light exit surface 13 of the entry light waveguide 1 and the point of impingement on the mirror and the distance between that point of impingement and the light entry surface 8 of the respective exit light waveguide 2 should be approximately the same for each spherical surface segment 11. That spacing, by virtue of the focusing properties of the curved spherical surface segments 11, should correspond approximately to half the radius thereof. The greater that radius is, the correspondingly smaller must the tilt angle be, with the same spacing in respect of the beam being coupled in. Slight distortion phenomena which the angular deviation causes can possibly be compensated again by an aspherical curvature if the construction requires a greater tilt angle. With a high degree of beam divergence a respective collimator can be arranged in the laser exit surfaces 13 of the entry light waveguide 1.

In the variant shown in FIG. 6 the laser light is divided by two entry light waveguides 1 on to respective pluralities of exit light waveguides 2. That is an attractive proposition in particular when laser ignition arrangements are to be provided for V-engines as here the laser beam must be divided in phase-displaced relationship for each bank of cylinders, for which purpose two multiplexers would otherwise be required. By a suitable increase in the number of entry light waveguides 1 and exit light waveguides 2 it is also possible to replace more than two multiplexers by means of an apparatus according to the invention. That is always desirable in order to keep the reflection angles low if as shown in FIG. 6 the entry light waveguide or waveguides 1 is or are arranged centrally between the exit light waveguides 2 associated with it or them. The variant shown in FIG. 6 permits a rapid switching-over action. The distance in which the laser light beam can freely propagate in air can be kept small. Furthermore the distance in which the laser beam propagates freely in air also remains constant over the entire spherical surface segment 11. In addition a focusing effect occurs with the spherically curved mirrors 11. That means that it is possible to dispense with an additional focusing lens. The curvature of the mirrors or spherical surface segments 11 can be so selected that an astigmatic beam acquires a symmetrical intensity profile. The laser light beam, on passing through a spherical surface segment 11, is deflected in a stable condition on to only one respective light entry surface 5 of an exit light waveguide. The rotation of the light deflection element 4 means that there is a low level of loading on the reflection surface 10 as the laser light constantly impinges on a different location of the reflection surface 10 by virtue of the rotation of the laser light. The drive for rotation of the annular light deflection element 4 as shown in FIG. 6 can also be effected as shown in FIGS. 1 through 5 by way of a motor and a step-down transmission. The latter can for example engage the ring 4 from the exterior by way of a tooth arrangement. The apparatus according to the invention can be in the form of a compact, self-contained structural unit with connections which are known in the state of the art, in particular for the exit light waveguides and optionally the entry light waveguide or waveguides.

1. An apparatus for the distribution of laser light from a light source, an entry light waveguide, or combinations thereof on to at least two exit light waveguides, wherein said apparatus comprises at least one light deflection element which rotates in operation of the apparatus and which is provided for deflecting laser light out of said entry light waveguide, said light source, or said combinations thereof in the direction of said exit light waveguides.

2. Apparatus as set forth in claim 1 wherein said laser light is distributed onto a plurality of exit light waveguides.

3. Apparatus as set forth in claim 1 wherein said light deflection element rotates continuously in operation of said apparatus.

4. Apparatus as set forth in claim 3 wherein said light deflection element in operation rotates continuously in one direction of rotation.

5. Apparatus as set forth in claim 1 wherein said light deflection element deflects said laser light successively in the direction of said various exit light waveguides.

6. Apparatus as set forth in claim 1 wherein said light deflection element is the single, movably mounted optically operative component of said apparatus.

7. Apparatus as set forth in claim 1 wherein the apparatus is suitable for the transmission of laser light involving a power of at least 10 W.

8. Apparatus as set forth in claim 7 wherein the apparatus is suitable for the transmission of pump laser light.

9. Apparatus as set forth in claim 7 wherein said apparatus is suitable for the transmission of laser light involving a power of at least 100 W.

10. Apparatus as set forth in claim 7 wherein said apparatus is suitable for the transmission of laser light with a level of efficiency of at least 80%.

11. Apparatus as set forth in claim 1 wherein said apparatus is suitable in continuous operation for the transmission of laser light onto each of the exit light waveguides during time intervals with interval lengths of between 50 μs and 8000 μs.

12. Apparatus as set forth in claim 11 wherein said apparatus is suitable in continuous operation for the transmission of laser light during time intervals with interval lengths of between 100 μs and 500 μs.

13. Apparatus as set forth in claim 1 wherein said apparatus is suitable for the transmission of laser light for a laser ignition arrangement for a stationary internal combustion engine.

14. Apparatus as set forth in claim 1 wherein said entry light waveguide, said exit light waveguides, or said combinations thereof are optical fibers.

15. Apparatus as set forth in claim 1 wherein said apparatus comprises a synchronisation device for synchronisation of the rotary movement of the light deflection element with a rotary speed of an internal combustion engine.

16. Apparatus as set forth in claim 1 wherein for rotation of the light deflection element said apparatus comprises a positionally accurate motor which can be matched to the rotary speed and the rotary angle of an internal combustion engine.

17. Apparatus as set forth in claim 16 wherein said motor is an electric motor.

18. Apparatus as set forth in claim 17 wherein said electric motor is a synchronous motor.

19. Apparatus as set forth in claim 1 wherein said apparatus comprises a step-down transmission for rotation of the light deflection element.

20. Apparatus as set forth in claim 1 wherein said apparatus comprises a focusing optical means for the light issuing from said light source, said entry light waveguide, or said combinations thereof.

21. Apparatus as set forth in claim 20 wherein said focusing optical means comprises a focusing lens.

22. Apparatus as set forth in claim 1 wherein said light deflection element is so designed that laser light transmitted through the light deflection element can be deflected by the light deflection element in its direction of propagation.

23. Apparatus as set forth in claim 22 wherein the focus of said laser light deflected in its direction of propagation.

24. Apparatus as set forth in claim 1 wherein the light deflection element comprises a prism.

25. Apparatus as set forth in claim 24 wherein said prism is of wedge shape.

26. Apparatus as set forth in claim 25 wherein at least two of the wedge surfaces of said wedge-shaped prism include with each other an angle of a maximum of 10°.

27. Apparatus as set forth in claim 26 wherein the maximum of said angle is 5°.

28. Apparatus as set forth in claim 1 wherein laser light entry surfaces of said exit light waveguides are arranged in mutually adjoining paired relationship on a closed line.

29. Apparatus as set forth in claim 28 wherein said closed line is a circle.

30. Apparatus as set forth in claim 1 wherein laser light entry surfaces of said exit light waveguides are arranged in rotationally symmetrical relationship.

31. Apparatus as set forth in claim 1 wherein the exit light waveguides are wound at least region-wise around a common center.

32. Apparatus as set forth in claim 22 wherein said light deflection element deflects the transmitted light through an angle of between 0.5° and 5°.

33. Apparatus as set forth in claim 32 wherein said angle is of between 1° and 2°.

34. Apparatus as set forth in claim 1 wherein the light deflection element is so designed that the laser light can be deflected by reflection at the laser deflection element in its direction of propagation.

35. Apparatus as set forth in claim 34 wherein said light deflection element is so designed that the focus of said laser light can be deflected by reflection at the laser deflection element in its direction of propagation.

36. Apparatus as set forth in claim 34 wherein the shape of the light deflection element is substantially annular, disk-shaped, or combinations thereof and has a reflection surface at its inside face or surface.

37. Apparatus according to claim 36 wherein the reflection surface extends in at least one direction in space over an angular range of 360°.

38. Apparatus as set forth in claim 36 wherein the reflection surface comprises a succession of mutually tilted adjoining, curved surface segments.

39. Apparatus as set forth in claim 38 wherein said curved surface segments are directly mutually adjoining curved surface segments.

40. Apparatus as set forth in claim 38 wherein said curved surface segments are spherical surface segments.

41. Apparatus as set forth in claim 40 wherein at least two spherical surface segments are of the same spherical radius.

42. Apparatus as set forth in claim 41 wherein all spherical surface segments are of the same spherical radius.

43. Apparatus as set forth in claim 40 wherein the center points of two respective adjacent spherical surface segments are displaced relative to each other in the direction of an axis of rotation of the annular light deflection element.

44. Apparatus as set forth in claim 40 wherein the center points of at least two spherical surface segments are disposed on an axis of rotation of the annular light deflection element.

45. Apparatus as set forth in claim 44 wherein the center points of all spherical surface segments are disposed on an axis of rotation of the annular light deflection element.

46. Apparatus as set forth in claim 34 wherein the magnitude of the angle between a laser light beam issuing from said light source, said entry light waveguide, or said combinations thereof and the laser light beam reflected at the light deflection element is at most 45°.

47. Apparatus as set forth in claim 46 wherein the magnitude of said angle is at most 20°.

48. Apparatus as set forth in claim 34 wherein a collimator optical means is arranged at the laser light exit surface of said entry light waveguide, said light source, or said combinations thereof.

49. Apparatus as set forth in claim 34 wherein a laser light exit surface of said light source, said entry light waveguide, or said combinations thereof and the laser light entry surfaces of the exit light waveguides are arranged centrally within the light deflection element, the shape of which being annular, disk-shaped, or both.

50. Apparatus as set forth in claim 49 wherein said laser light exit surface and said laser light entry surfaces of said exit light waveguides are arranged stationarily centrally within said light deflection element.

51. Apparatus as set forth in claim 1 wherein the light deflection element deflects the laser light from at least two light sources, entry light waveguides, or combinations thereof in the direction of at least two exit light waveguides.

52. Apparatus as set forth in claim 51 wherein said light deflection element deflects the laser light from a plurality of light sources, entry light waveguides, or combinations thereof in the direction of a plurality of exit light waveguides.

53. A laser ignition arrangement for an internal combustion engine comprising an apparatus as set forth in claim 1.

54. A laser ignition arrangement as set forth in claim 53 wherein said internal combustion engine is a gas engine.

55. An internal combustion engine comprising an apparatus as set forth in claim 1.

56. An internal combustion engine as set forth in claim 55 wherein said internal combustion engine is a gas engine.
